(19) United States
(12) Patent Application Publication
(10) Pub. No.: US 2012/0025016 A1
(43) Pub. Date: Feb. 2, 2012

(54) AIRCRAFT PROPELLER

(76) Inventors: Paul Nicholas METHVEN, Gloucester (GB); Angela Knepper, Cheltenham (GB); Diane Cuttell, Gloucester (GB)

(21) Appl. No.: 13/186,762

(22) Filed: Jul. 20, 2011

(30) Foreign Application Priority Data
Jul. 30, 2010 (GB) 1012832.0

(51) Int. Cl. B64C 11/46; F01D 1/24; B64C 1/40; B64C 11/16; B64C 11/00; B64D 27/00

(52) U.S. Cl. 244/1 N; 244/65; 244/69; 416/203; 416/128

(57) ABSTRACT

A propeller for an aircraft is disclosed. The propeller has an odd number of unequally circumferentially spaced blades. The propeller may be provided as part of a contra-rotating propeller arrangement and/or aft of a pylon on an aircraft. The propeller has been found to reduce noise levels and to be efficient.

### BACKGROUND OF THE INVENTION

1. Field of the Invention

The field of invention relates to propellers for an aircraft

2. Description of Related Art

In order for an aircraft propeller to be more easily balanced for smooth and effective use, it generally has an even number of blades. Each pair of blades is arranged in longitudinal alignment with each other on opposite sides of and radially of the axis of rotation of the propeller. When the blades of the propeller are equally spaced, the discrete frequency noise of the acoustic spectrum is characterised by a single fundamental blade passing frequency and its harmonics. The blade passing frequency is the product of the number of blades and the rotational tip speed of the propeller. The harmonics are integer multiples of the blade passing frequency. Hence, the acoustic spectrum of a propeller with equally spaced blades is typified by regularly spaced pronounced “peaks” of sound energy, coinciding with the fundamental blade passing frequency and its harmonics. However, with the blades equally spaced, the fundamental frequency and its harmonics essentially reinforce each other, adversely affecting the perceived noise.

By spacing the propeller blades unequally, a fundamental blade passing frequency is generated for each unique angle between the blades. In turn, each fundamental frequency generates a set of harmonics. Whilst spacing the blades equally distributes the sound energy over a single fundamental blade passing frequency and one set of harmonics, unequally spaced blades distribute the same acoustic energy over a broader range of frequencies. Unequally spaced blades may also modify the decay rate with frequency of the sound pressure levels of the harmonics. Thus, whilst the sound pressure level of the fundamental frequency may be higher and more harmonics may occur when the blades are unequally spaced, the overall perceived noise may still be reduced, due to the favourable interaction of the fundamental frequencies and/or the harmonics. it has been found that unequally spaced blades do not adversely affect the propeller performance. U.S. Pat. No. 5,096,383 discloses a propeller with six blades which are unsymmetrically arranged around the axis of rotation of the propeller.

Whilst six bladed propellers are known it would to be desirable to have a propeller with more blades to increase efficiency. Minimising the number of blades increases reliability and reduces cost. Therefore, having the opportunity to use an odd or even number of blades allows full optimization of the propeller design.

It would be desirable to provide a propeller in which at least some of the problems discussed above were at least reduced.

### BRIEF SUMMARY OF THE INVENTION

According to embodiments of the present invention there is provided a propeller for an aircraft, the propeller comprising an odd number of blades and wherein the odd number of blades are unequally spaced.

It has been surprisingly found that a propeller can be provided with an odd number of unequally spaced blades which may be angularly spaced relative to each other such that the propeller is balanced. Providing an odd number of blades makes the propeller more efficient than the corresponding conventional propeller with one less blade whilst reducing the disadvantages associated with designing a propeller with an increased number of even blades.

It is even more surprising that a balanced propeller may be provided with an odd number of blades that are unequally spaced. The unequal spacing enables the perceived noise to be reduced as discussed above. Each blade is preferably mounted radially about an axis of rotation such as by being mounted on a rotatable hub. At least one blade is preferably angularly separated from its two neighbouring blades by two different circumferential angles in the plane of rotation.

The propeller may comprise five unequally spaced blades which is more efficient than a four bladed propeller and less expensive and complicated than a six bladed propeller. The propeller may comprise seven unequally spaced blades which is more efficient than a six bladed propeller but is less expensive and complicated than an eight bladed propeller.

The propeller may be arranged with another propeller to provide a contra-rotating propeller arrangement which comprises a second propeller positioned axially aft of the first propeller, rotating in an opposite direction.

The propeller or contra-rotating propeller arrangement may be provided to operate aft of a pylon attached to an aircraft such that the frequency of interaction of the pylon wake with the rotor blades would be variable reducing both the sound levels and perceived noise.

The propeller may be provided with a controller for controlling the speed of the propeller in use to actively control the noise produced by the propeller.

### BRIEF DESCRIPTION OF THE SEVERAL VIEWS OF THE DRAWINGS

Embodiments of the present invention will now be described, by way of example only, with reference to the accompanying drawings, in which:

FIG. 1 shows a propeller with five unequally spaced blades;

FIG. 2 shows the propeller of FIG. 1 with the perpendicularly resolved forces of each blade illustrated;

FIG. 3 shows a propeller with seven unequally spaced blades.

FIG. 4 shows a contra-rotating rotating propeller arrangement;

FIG. 5 shows a propeller provided aft of a pylon attached to an aircraft

FIG. 6 shows a contra-rotating propene arrangement provided aft of a pylon. attached to an aircraft and

FIG. 7 schematically shows an arrangement for actively controlling the speed of the propeller.

### DETAILED DESCRIPTION OF THE INVENTION

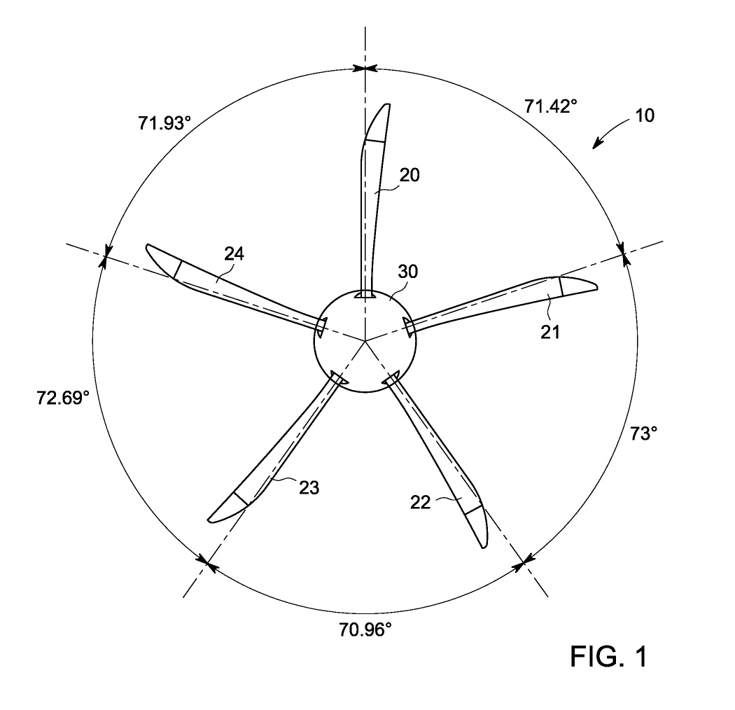

As shown in the example of FIG. 1, the embodiments of the present invention provide a propeller 10 for an aircraft with an odd number, in this case five, unequally angularly circumferentially spaced blades 20, 21, 22, 23, 24. The circumferential angle between each pair of blades in this example is 71.42°, 73°, 70.96°, 72.69° and 71.93°. It has surprisingly been found that the unequally circumferentially spaced blades produce a balanced propeller for smooth and efficient use, being more efficient than an equivalent four bladed propeller whilst reducing noise levels due to the unequal circumferential spacing and being less expensive and complicated than a six bladed propeller.

In this example each of the blades 20, 21, 22, 23, 24 is mounted to a rotatable hub 30. The hub may be rotated by any suitable means as is well known to a person skilled in the art, such as an engine. Examples of engines may include a piston or turbo prop engine. Although all of the blades are shown mounted to the hub 30 in FIG. 1, any suitable arrangement for mounting the blades to a suitable axis of rotation may be used as will be known to a person skilled in the art.

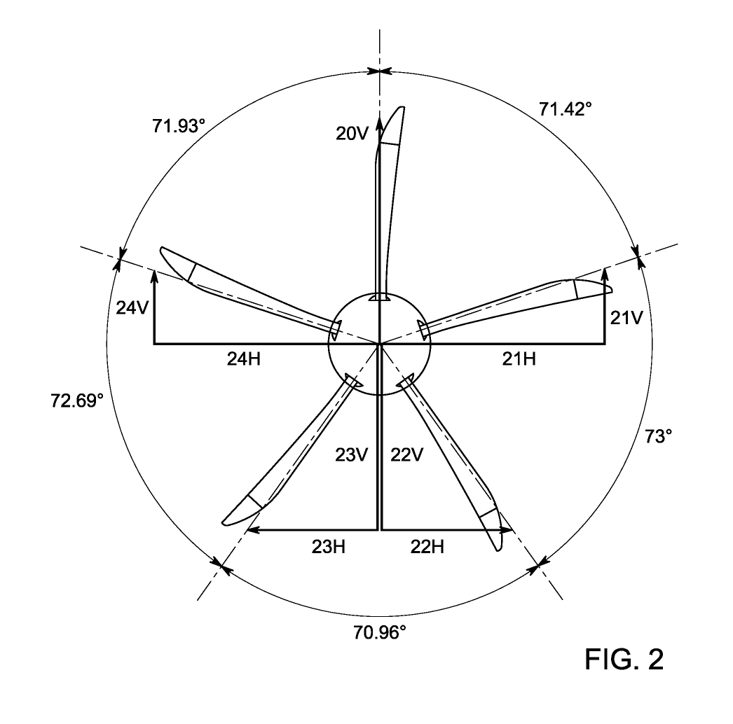

FIG. 2 illustrates how the spacing of the blades around the hub may be determined to ensure that the propeller is balanced when in use. The positioning of the blades is such that the resolved perpendicular forces in the plane of the blades is balanced. For example, in the embodiment of FIG. 2, the resolved vertical and horizontal forces for each blade are illustrated schematically. The total of the forces 20V, 21V, 22V, 23V and 24V is zero and the total of the corresponding resolved horizontal forces 21H, 22H, 23H and 24H is also zero ensuring that the overall propeller 10 is balanced in use. Clearly the precise positioning of the blades may be varied, for example to optimise noise reduction, provided that the resolved perpendicular forces in the plane of the blades is balanced.

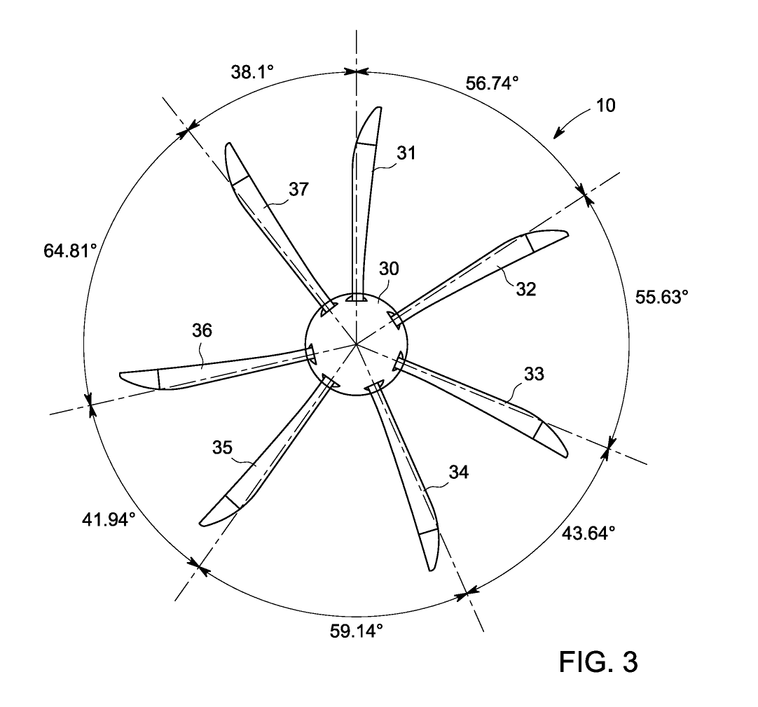

FIG. 3 shows a further example of a propeller 10 with an odd number, in this case seven, unequally circumferentially spaced blades 31, 32, 33, 34, 35, 36 and 37. As in the example of FIGS. 1 and 2, the blades are unequally circumferentially spaced but have balanced resolved perpendicular forces in the plane of the blades such that the propeller 10 is balanced in use. It has surprisingly been found that the unequally circumferentially spaced blades produce a balanced propeller 10 for smooth and efficient use, being more efficient than an equivalent six bladed. propeller whilst reducing noise levels due to the unequal circumferential spacing and being less expensive and complicated than an eight bladed propeller.

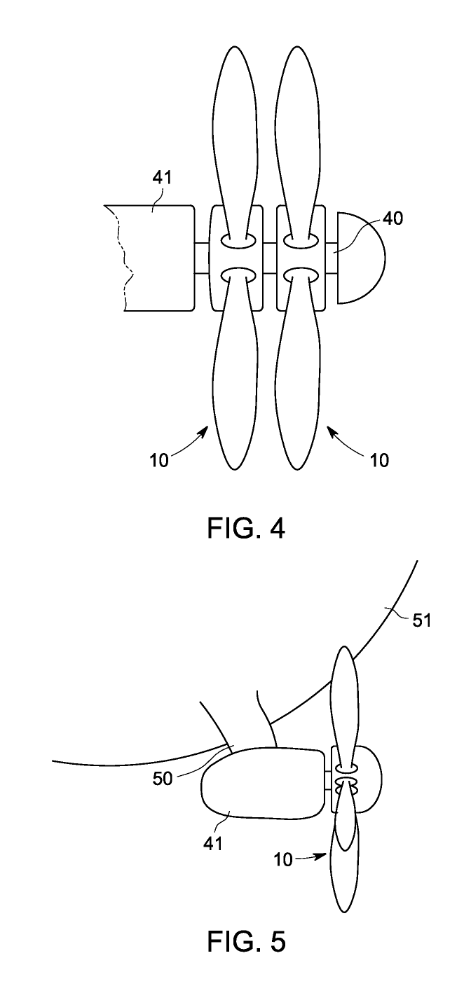

FIG. 4 schematically shows a side view of a contra-rotating propeller arrangement with two propellers 10 arranged to be driven in opposite rotation, Contra-rotating propellers have been found to be more efficient than a single propeller since a single engine can be used to drive the two propellers 10. However, contra-rotating propellers can be noisy.

It has been found that a contra-rotating propeller in which at least one of the propellers, and preferably both, comprise a propeller with an odd number of unequally spaced blades as in embodiments of the present invention provide a contra-rotating propeller with enhanced efficiency but with reduced noise levels, The example shown in FIG. 4 has two propellers 10 arranged one behind the other on a coaxial shaft 40 driven by the engine 41 via a gear transmission (not shown) such as a planetary gear or spur gear transmission for example. The use of propellers 10 of embodiments of the present invention in a contra-rotating propeller arrangement as shown in FIG. 4 reduce the noise problems associated with efficient contra-rotating propeller arrangements.

FIG. 5 shows a propeller of an embodiment of the present invention arranged to operate aft of a pylon 50 attached to an aircraft 51. By spacing the blades non-symmetrically, the frequency of interaction of the pylon wake with the rotor blades would be variable, Hence, unequally spaced blades have the effect of reducing both the sound levels and perceived noise of a propeller installed aft of a pylon 50.

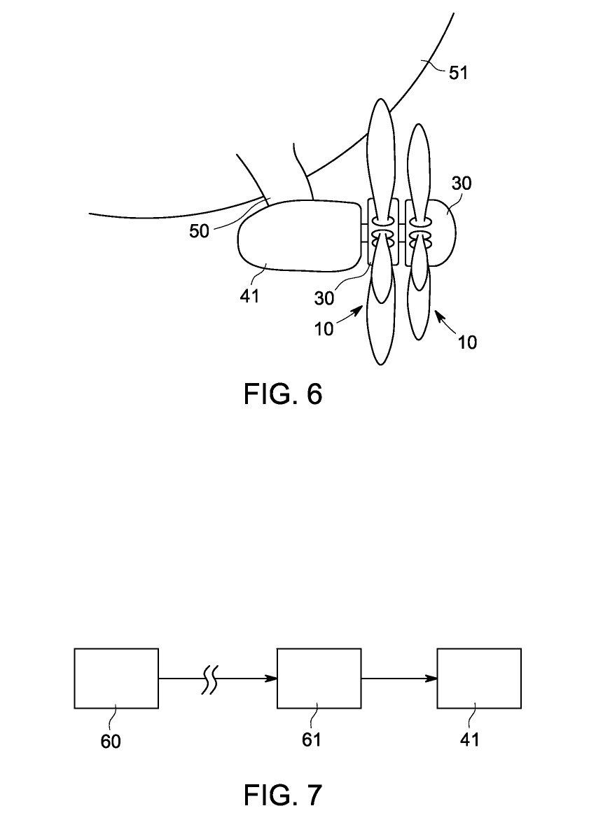

FIG. 6 is similar to FIG. 5 except that it shows a contra-rotating propeller as in FIG. 4 installed aft of a pylon 50. The arrangement of FIG. 6 comprising a contra-rotating propeller installed aft of a pylon 50 would normally suffer from noise problems caused by the interaction of airflow over the pylon 50 and between the two propellers 10. However, by using at least one, and preferably both propellers 10 of embodiments of the present invention with an odd number of unequally spaced blades it has been found that the noise levels are significantly reduced.

FIG. 7 schematically illustrates a controller 61 for controlling the speed of a propeller or a contra-rotating propeller arrangement in use to actively control the noise produced by the propeller. One or more sensors 60 such as microphones which may be provided within the aircraft, for example in a passenger area, may be arranged to provide output signals, either directly or for example over a wireless link, to the controller 61. The controller 61 may then be arranged to control the speed of the propeller to change the phase of the propeller blades relative to the other propellers on the aircraft, to actively control the amount of noise produced. In this way, the one optimum phase position can then be found between 0 degrees and 360 degrees. The active control arrangement of FIG. 7 may be used to further enhance the noise reduction provided by the propeller 10 of embodiments of the present invention.

Many variations may be made to the examples described above without departing from the scope of the present invention. For example the blades of the propellers illustrated in FIGS. 1 to 3 may have any desired circumferential separation angles provided that the propeller is arranged, in use, to be balanced. The blades and hub 30 may be made from any suitable materials as will be well known to a person skilled in the art.

What is claimed is:

1. A propeller for an aircraft, the propeller comprising an odd number of blades and wherein at least some of the blades are unequally angularly spaced from each other.

2. A propeller according to claim 1, wherein each blade is mounted radially about an axis of rotation.

3. A propeller according to claim 1, wherein at least one blade is angularly separated from its two neighbouring blades by two different circumferential angles.

4. A propeller according to claim 1, wherein the blades are provided in a plane of rotation.

5. A propeller according to claim 1, wherein the total resolved perpendicular forces of the blades of the propeller are balanced.

6. A propeller according to claim 1, comprising five blades.

7. A propeller according to claim 1 comprising seven blades.

8. A contra-rotating propeller arrangement comprising two propellers arranged to co-axially rotate in opposite directions wherein at least one of the propellers is a propeller comprising an odd number of blades and wherein at least some of the blades are unequally angularly spaced from each other.

9. A contra-rotating propeller arrangement according to claim 8, wherein both propellers are propellers comprising an odd number of blades and wherein at least some of the blades are unequally angularly spaced from each other.

10. An aircraft comprising a propeller comprising an odd number of blades and wherein at least some of the blades are unequally angularly spaced from each other.

11. An aircraft according to claim 10, wherein the aircraft comprises a pylon and wherein the propeller is provided aft of the pylon.

12. An aircraft according to claim 110, comprising a sensor for detecting noise produced by the propeller and a controller for controlling the speed of the propeller, in use, dependent upon an output from the sensor to actively control the noise produced by the propeller.

13. An aircraft according to claim 12, wherein the sensor is provided on the aircraft.

14. An aircraft according to claim 12, wherein the propeller comprises one optimum phase position between 0 degrees and 360 degrees.

15. An aircraft comprising a contra-rotating propeller arrangement comprising two propellers arranged to co-axially rotate in opposite directions wherein at least one of the propellers is a propeller comprising an odd number of blades and wherein at least some of the blades are unequally angularly spaced from each other.

16. An aircraft according to claim 15, wherein the aircraft comprises a pylon and wherein the contra-rotating propeller arrangement is provided aft of the pylon.

17. An aircraft according to claim 15, comprising a sensor for detecting noise produced by the propeller and a controller for controlling the speed of the propeller, in use, dependent upon an output from the sensor to actively control the noise produced by the propeller.

18. An aircraft according to claim 17, wherein the sensor is provided on the aircraft.

19. An aircraft according to claim 17, wherein the propeller comprises one optimum phase position between 0 degrees and 360 degrees.
